(19) United States
(12) Patent Application Publication
(10) Pub. No.: US 2024/0378801 A1
(43) Pub. Date: Nov. 14, 2024

(54) Embedding Digital Signatures with Content Created by Users Sharing a Virtual Environment

(71) Applicant: Google LLC, Mountain View, CA (US)

(72) Inventor: Diego Rivas Vetencourt, San Francisco, CA (US)

(21) Appl. No.: 18/315,719

(22) Filed: May 11, 2023

(51) Int. Cl. G06T 17/00; H04L 9/32

(52) U.S. Cl. CPC G06T 17/00; H04L 9/3247

(57) ABSTRACT

Attribution is provided to content creators in a virtual environment by providing a virtual three-dimensional (3D) environment in which first and second users simultaneously view the virtual 3D environment. A first input associated with the first user is received to cause a generative machine-learned model to generate a first virtual object that is embedded with a first unique digital signature associated with the first user. A second input associated with the second user is received to cause the generative machine-learned model to generate a second virtual object based on the second input and contextual information associated with the second user, the second virtual object being embedded with a second unique digital signature associated with the second user. A third unique digital signature associated with the first and second users is associated with the virtual 3D environment including the first and second virtual objects.

### FIELD

The disclosure relates generally to methods and computing systems for providing a collaborative creation space (e.g., a three-dimensional virtual environment) for a plurality of users through which content can be created via inputs (e.g., prompts) provided by the plurality of users using one or more generative machine-learned models. For example, the disclosure relates to methods and computing systems for embedding a digital signature with content (e.g., a virtual object, a virtual environment, etc.) which is associated with one or more users that created the content.

### BACKGROUND

Generative artificial intelligence (AI) refers to an area of artificial intelligence that involves machines generating data or content (e.g., text, images, videos, or other media) in response to receiving a prompt. Generative machine-learned models (or generative AI tools) are typically trained on large datasets of existing examples, and they use that data to learn patterns and create new, original content. For example, a generative machine-learned model (e.g., DALL-E, Generative Adversarial Network, etc.) may receive a prompt (e.g., a natural language prompt) to generate an image of “a cat wearing a tutu while playing a guitar.” The generative machine-learned model may use deep learning algorithms to learn patterns and features from large datasets of images to create the image according to the prompt.

### SUMMARY

Aspects and advantages of embodiments of the disclosure will be set forth in part in the following description, or can be learned from the description, or can be learned through practice of the example embodiments.

In one or more example embodiments, a computer implemented method for creating content in a collaborative virtual three-dimensional environment is provided. For example, the method includes providing, by a computing system, a virtual three-dimensional (3D) environment in which a first user and a second user simultaneously view the virtual 3D environment; receiving, by the computing system, a first input associated with the first user, to cause a generative machine-learned model to generate a first virtual object within the virtual 3D environment, the first virtual object being embedded with a first unique digital signature associated with the first user; receiving, by the computing system, a second input associated with the second user, to cause the generative machine-learned model to generate a second virtual object within the virtual 3D environment, the second virtual object being generated based on the second input and contextual information associated with the second user and the second virtual object being embedded with a second unique digital signature associated with the second user; and causing, by the computing system, a third unique digital signature to be associated with the virtual 3D environment including the first virtual object and the second virtual object, the third unique digital signature being associated with the first user and the second user.

In some implementations, the one or more of the first unique digital signature, the second unique digital signature, and the third unique digital signature, comprises a non-fungible token.

In some implementations, the method further includes, in response to generating the second virtual object, providing the second user access to another virtual 3D environment using the second unique digital signature or using a separate property embedded with the second virtual object.

In some implementations, the method further includes identifying, by the computing system, the another virtual 3D environment as a virtual 3D environment to provide access to the second user to, based on at least one of the second input associated with the second user or the contextual information associated with the second user. The separate property may include a digital utility token.

In some implementations, the method further includes in response to the generation of the second virtual object, providing the second user access to a real-world experience using the second unique digital signature or using a separate property embedded with the second virtual object.

In some implementations, the method further includes identifying, by the computing system, the real-world experience as a real-world experience to provide access to the second user to, based on at least one of the second input associated with the second user or the contextual information associated with the second user. The separate property may include a digital utility token.

In some implementations, the method further includes receiving, by the computing system, a third input associated with the first user, to cause the generative machine-learned model to modify the second virtual object to generate a modified second virtual object within the virtual 3D environment, the modified second virtual object being generated based on the third input and contextual information associated with the first user and the modified second virtual object being embedded with a fourth unique digital signature associated with the first user.

In some implementations, the method further includes obtaining, by the computing system, the contextual information associated with the first user based on at least one of a user profile associated with the first user, preferences associated with the first user, or information about the first user obtained from an external source.

In some implementations, the method includes receiving, by the computing system, a third input associated with an entity not simultaneously viewing the virtual 3D environment with the first user and the second user, to cause the generative machine-learned model to modify the second virtual object to generate a modified second virtual object within the virtual 3D environment, the modified second virtual object being generated based on the third input and contextual information associated with the entity and the modified second virtual object being embedded with a fourth unique digital signature associated with the entity.

In some implementations, the method includes obtaining, by the computing system, the contextual information associated with the entity based on information about the entity obtained from an external source.

In some implementations, the virtual 3D environment includes a virtual reality environment or an augmented reality environment.

In some implementations, the method includes receiving, by the computing system, a third input associated with the first user, to cause the generative machine-learned model to modify the virtual 3D environment by changing an environmental condition of the virtual 3D environment to generate a modified virtual 3D environment, the modified virtual 3D environment being embedded with a fourth unique digital signature associated with the first user.

In some implementations, the environmental condition includes one more of a lighting condition of the virtual 3D environment, a weather condition of the virtual 3D environment, a noise condition of the virtual 3D environment, a time of day in the virtual 3D environment, or a geographic location of the virtual 3D environment.

In one or more example embodiments, a computing device (e.g., a server computing system, a laptop, tablet, smartphone, etc.) is provided. The computing device may include one or more processors; and one or more non-transitory computer-readable media that store instructions that, when executed by the one or more processors, cause the computing system to perform operations. For example, the operations may include providing a virtual three-dimensional (3D) environment in which a first user and a second user simultaneously view the virtual 3D environment; receiving a first input associated with the first user, to cause a generative machine-learned model to generate a first virtual object within the virtual 3D environment, the first virtual object being embedded with a first unique digital signature associated with the first user; receiving a second input associated with the second user, to cause the generative machine-learned model to generate a second virtual object within the virtual 3D environment, the second virtual object being generated based on the second input and contextual information associated with the second user and the second virtual object being embedded with a second unique digital signature associated with the second user; and causing a third unique digital signature to be associated with the virtual 3D environment including the first virtual object and the second virtual object, the third unique digital signature being associated with the first user and the second user.

In some implementations, one or more of the first unique digital signature, the second unique digital signature, and the third unique digital signature, comprises a non-fungible token.

In some implementations, the operations further comprise: receiving a third input associated with the first user, to cause the generative machine-learned model to modify the second virtual object to generate a modified second virtual object within the virtual 3D environment, the modified second virtual object being generated based on the third input and contextual information associated with the first user and the modified second virtual object being embedded with a fourth unique digital signature associated with the first user.

In some implementations, the operations further comprise: receiving a third input associated with an entity not simultaneously viewing the virtual 3D environment with the first user and the second user, to cause the generative machine-learned model to modify the second virtual object to generate a modified second virtual object within the virtual 3D environment, the modified second virtual object being generated based on the third input and contextual information associated with the entity and the modified second virtual object being embedded with a fourth unique digital signature associated with the entity.

In one or more example embodiments, a computer implemented method for creating content in a collaborative virtual three-dimensional environment is provided. For example, the method includes providing, by a computing system, a virtual three-dimensional (3D) environment in which a first user and a second user simultaneously view the virtual 3D environment; receiving, by the computing system, a first input associated with the first user, to cause a generative machine-learned model to generate a first virtual object within the virtual 3D environment and change an environmental condition of the virtual 3D environment to generate a modified virtual 3D environment, the first virtual object being embedded with a first unique digital signature associated with the first user and the modified virtual 3D environment being embedded with a second unique digital signature associated with the first user; receiving, by the computing system, a second input associated with the second user, to cause the generative machine-learned model to modify the first virtual object to generate a modified first virtual object within the virtual 3D environment, the modified first virtual object being generated based on the second input and contextual information associated with the second user and the modified first virtual object being embedded with a third unique digital signature associated with the second user; causing, by the computing system, a fourth unique digital signature to be associated with the modified virtual 3D environment including the modified first virtual object, the fourth unique digital signature being associated with the first user and the second user; and in response to the generation of the first virtual object or the modified virtual 3D environment, providing access to one or more of a real-world experience or another virtual environment experience to the first user, using the first unique digital signature or the second unique digital signature.

In one or more example embodiments, a computer-readable medium (e.g., a non-transitory computer-readable medium) which stores instructions that are executable by one or more processors of a computing system is provided. In some implementations the computer-readable medium stores instructions which may include instructions to cause the one or more processors to perform one or more operations which are associated with any of the methods described herein (e.g., operations of the server computing system and/or operations of the computing device). For example, the operations may include operations providing a virtual three-dimensional (3D) environment in which a first user and a second user simultaneously view the virtual 3D environment; receiving a first input associated with the first user, to cause a generative machine-learned model to generate a first virtual object within the virtual 3D environment, the first virtual object being embedded with a first unique digital signature associated with the first user; receiving a second input associated with the second user, to cause the generative machine-learned model to generate a second virtual object within the virtual 3D environment, the second virtual object being generated based on the second input and contextual information associated with the second user and the second virtual object being embedded with a second unique digital signature associated with the second user; and causing a third unique digital signature to be associated with the virtual 3D environment including the first virtual object and the second virtual object, the third unique digital signature being associated with the first user and the second user. The computer-readable medium may store additional instructions to execute other aspects of the server computing system and computing device and corresponding methods of operation, as described herein.

These and other features, aspects, and advantages of various embodiments of the disclosure will become better understood with reference to the following description, drawings, and appended claims. The accompanying drawings, which are incorporated in and constitute a part of this specification, illustrate example embodiments of the disclosure and, together with the description, serve to explain the related principles.

### BRIEF DESCRIPTION OF THE DRAWINGS

Detailed discussion of example embodiments directed to one of ordinary skill in the art is set forth in the specification, which makes reference to the appended drawings, in which:

FIG. 1 illustrates an example system, according to one or more example embodiments of the disclosure;

FIGS. 2-5 illustrate example flow diagrams of non-limiting computer-implemented methods, according to one or more example embodiments of the disclosure;

FIGS. 6A-6B illustrate example virtual environments for creating content, according to one or more example embodiments of the disclosure; and

FIGS. 7A-7B illustrate example systems, according to one or more example embodiments of the disclosure.

### DETAILED DESCRIPTION

Examples of the disclosure are directed to methods and computing systems for providing a collaborative creation space (e.g., a three-dimensional virtual environment) for a plurality of users through which content can be created via prompts provided by the plurality of users using one or more generative machine-learned models. For example, a digital asset (or feature) that is created by a user (or users) within the creation space may be provided with a unique digital signature or identifier that is associated with that user (or users). Therefore, a collective experience may be provided to the plurality of users who contribute to the creation of the content in the creation space, while also ensuring attribution to respective users with respect to one or more portions of the creation space that are created by the respective users.

This application also relates to methods and computing systems for linking the collaborative creation space for the plurality of users to another creation space. For example, when the collaborative creation space is generated, or when an asset is created by a user, a link through which additional content can be accessed may be generated.

In some implementations, when the collaborative creation space is generated the creation space may be provided with a property or feature which links the creation of the creation space with another creation space or experience. For example, the property or feature may be a key or an entry token that provides or grants access to the other creation space or experience. For example, the entry token may provide access to another virtual creation space (e.g., a virtual meeting, a virtual concert, etc.) or to a real-world physical experience (e.g., a concert, a sporting event, etc.).

In some implementations, when an asset is created by a user in the collaborative creation space the asset may be provided with a property or feature which links the creation of the asset with another creation space or experience. For example, the property or feature may be a key or an entry token that provides or grants access to the other creation space or experience. For example, the entry token may provide access to another virtual creation space (e.g., a virtual meeting, a virtual concert, etc.) or to a real-world physical experience (e.g., a concert, a sporting event, etc.).

The methods and computing systems described herein provide numerous technical effects and benefits including an improved and more accurate method for ensuring ownership of digital content created in a collaborative manner can be attributed to users or entities in a secure and effective manner. For example, by applying or embedding a digital signature to content created by a user during a collaborative experience, disputes or errors in attribution can be avoided or prevented. As another example, access to another virtual space or a real-world experience which is relevant to the user or entity can be accurately provided by reference to prompts and/or content associated with the user. Therefore, computing resources may be efficiently utilized by not providing access to virtual events or experiences which are likely not of interest to the user.

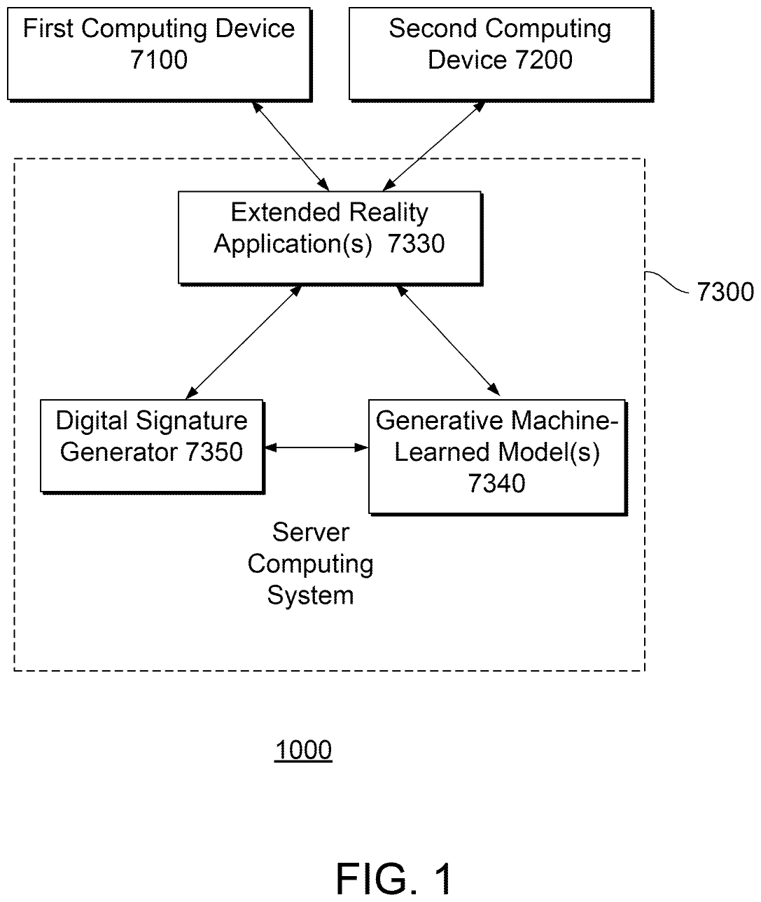

Referring now to the drawings, FIG. 1 illustrates an example system for generating content, according to one or more example embodiments of the disclosure. For example, the system 1000 illustrated in FIG. 1 includes a first computing device 7100, a second computing device 7200, and a server computing system 7300 which includes one or more extended reality applications 7330, one or more generative machine-learned models 7340, and a digital signature generator 7350.

The first computing device 7100 can be any type of computing device, such as, for example, a personal computing device (e.g., laptop or desktop), a mobile computing device (e.g., smartphone or tablet), a gaming console or controller, a wearable computing device (e.g., a virtual/augmented reality device, etc.), an embedded computing device, a broadcasting computing device (e.g., a webcam, etc.), or any other type of computing device. Likewise, the second computing device 7200 can be any type of computing device, such as, for example, a personal computing device (e.g., laptop or desktop), a mobile computing device (e.g., smartphone or tablet), a gaming console or controller, a wearable computing device (e.g., a virtual/augmented reality device, etc.), an embedded computing device, a broadcasting computing device (e.g., a webcam, etc.), or any other type of computing device.

The server computing system 7300 may receive inputs from the first computing device 7100 and second computing device 7200 to implement the one or more extended reality applications 7330. The one or more extended reality applications 7330 (e.g., a virtual reality application, an augmented reality application, etc.) may be configured to provide a virtual environment (e.g., an immersive virtual three-dimensional environment, an augmented-reality environment, etc.) that is shared and simultaneously viewed by users of the first computing device 7100 and second computing device 7200.

To provide an example, the server computing system 7300 may include the one or more extended reality applications 7330 which are configured to provide a virtual three-dimensional (3D) environment to a plurality of users (e.g., to the first computing device 7100 associated with a first user and to the second computing device 7200 associated with a second user) over a network. For example, the virtual 3D environment may be viewed by a first user wearing a virtual reality headset, virtual reality goggles, and the like. Users can interact with virtual (digital) objects or avatars in the virtual 3D environment which provides an immersive experience for the user. Users can also interact with or control environmental conditions of the virtual 3D environment (e.g., lighting, sound, weather, etc.) to provide an enhanced user experience. In some implementations, the server computing system 7300 may include one or more generative machine-learned models 7340 implemented by the one or more extended reality applications 7330 to generate content within the virtual 3D environment. The virtual 3D environment may be associated with a gaming environment, a simulation environment (e.g., aviation, medicine, etc.), education and training environment, an art and design environment, and the like.

The one or more extended reality applications 7330 may be configured to render or generate virtual objects in the virtual 3D environment according to an input received from a user via a computing device, according to an output of a generative machine-learned model, and the like. As an example implementation, the one or more extended reality applications 7330 may provide a virtual 3D environment which includes a home with numerous rooms that can be virtually explored by a plurality of users associated with a plurality of computing devices. For example, in a living room setting which is not furnished, a first user of first computing device 7100 may wish to see what the living room would look like with a chair and a couch. The first user may provide a first prompt (e.g., via a keyboard, mouse, voice input, etc.) to the one or more extended reality applications 7330 requesting to “show me what this room looks like with a couch and a chair.” In response, the one or more generative machine-learned models 7340 implemented by the one or more extended reality applications 7330 may generate first and second virtual objects corresponding to a couch and a chair, respectively. For example, the first and second virtual objects may be generated according to the first prompt based on deep learning algorithms that learn patterns and features from large datasets of images to create images which resemble or represent a couch and chair.

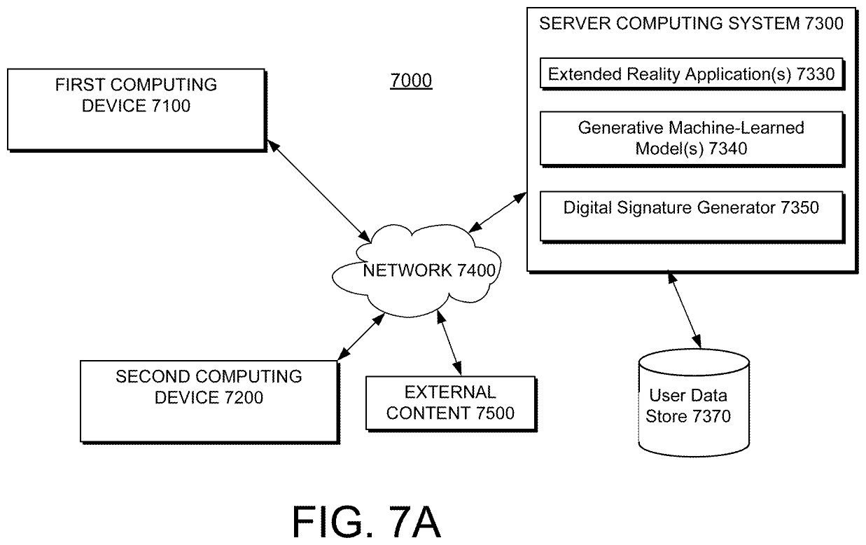

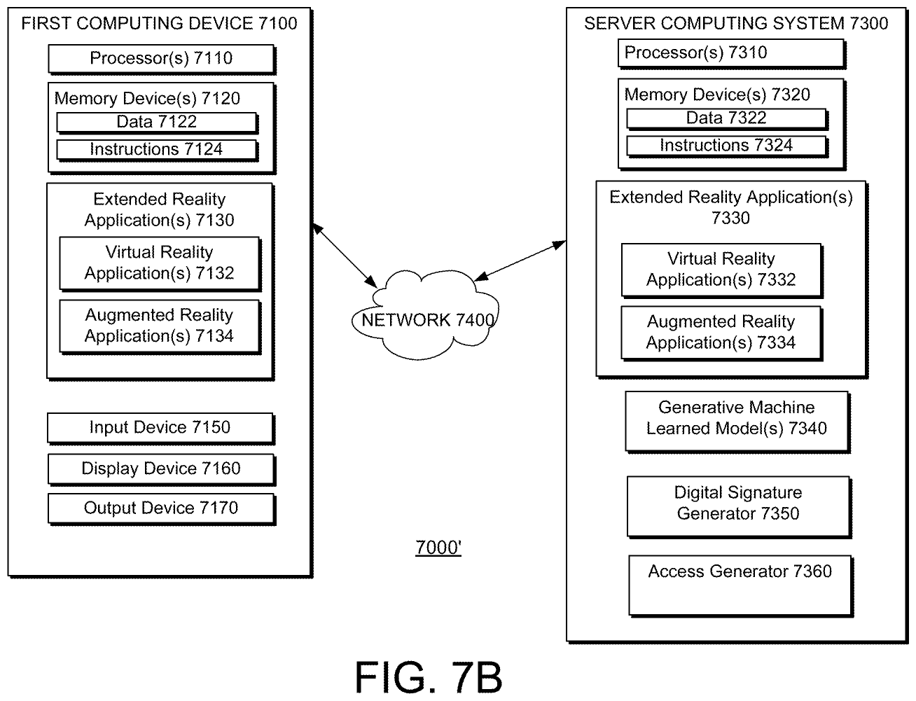

A second user of the second computing device 7200 (e.g., among a plurality of users) who is also viewing the living room together with the first user in a shared immersive viewing experience may subsequently provide a second prompt (e.g., via a keyboard, mouse, voice input, etc.) to the one or more extended reality applications 7330 requesting “I would like the chair to look more like the one I have in my living room.” In response, the one more generative machine-learned models 7340 may modify the second virtual object corresponding to the chair to generate a modified second virtual object, based on the contextual information provided in the second prompt from the second user. For example, the modified second virtual object may be generated according to the second prompt based on deep learning algorithms that learn patterns and features from large datasets of images to create an image which resembles or represents the chair requested by the second user. In some implementations, the one or more generative machine-learned models 7340 may (with appropriate permissions and user consent) access information associated with one of the users to generate a virtual object (e.g., user preferences, user data, etc.). For example, the one or more generative machine-learned models 7340 may (with appropriate permissions and user consent) access photos or videos (e.g., via user data store 7370 from FIG. 7BA) associated with the second user that contain imagery of the second user's living room and/or the one or more generative machine-learned models 7340 may generate the modified representation of the chair based on information associated with the second user which indicates a preference for mid-century furniture.

In conjunction with the creation of the virtual objects within the virtual 3D environment based on the collaborative effort of the first and second users, each virtual object and/or each version of a virtual object, as well as the virtual 3D environment containing the virtual object(s), may be embedded with a digital signature generated by digital signature generator 7350 that indicates an association (e.g., creative ownership) between the virtual object and a corresponding user.

For example, the first and second virtual objects generated in response to the first prompt may include or be embedded with a digital signature generated by digital signature generator 7350 which is associated with the first user. For example, the digital signature may include a private key that encrypts a hash value of a corresponding virtual object. As another example, the first and second objects may include or be embedded with a unique identifier (UID) generated by digital signature generator 7350 that is assigned to the first user which indicates ownership of the first and second virtual objects created based on the first prompt provided by the first user. As another example, the first and second objects may include or be embedded with a digital token (e.g., a non-fungible token) generated by digital signature generator 7350 that represents ownership of a respective virtual object. The digital token may be issued (e.g., using blockchain or other distributed ledger technology) by a trusted authority (e.g., the server computing system 7300) and can be stored and transferred securely using blockchain or other distributed ledger technology. For example, ownership of an NFT or other digital token can be transferred through the blockchain, and the transaction history may be stored on the ledger, providing a transparent and immutable record of ownership.

For example, the modified second virtual object generated in response to the second prompt may include or be embedded with a digital signature generated by digital signature generator 7350 which is associated with the second user. For example, the digital signature may include a private key that encrypts a hash value of a corresponding virtual object. As another example, the modified second virtual object may include or be embedded with a unique identifier (UID) generated by digital signature generator 7350 that is assigned to the second user which indicates ownership of the modified second virtual object created based on the second prompt provided by the second user. As another example, the modified second virtual object may include or be embedded with a digital token (e.g., a non-fungible token) generated by digital signature generator 7350 that represents ownership of a respective virtual object.

For example, the overall collective virtual 3D environment containing the first and second virtual objects which are generated in response to the first prompt may include or be embedded with a digital signature generated by digital signature generator 7350 which is associated with the first user. Likewise, the overall collective virtual 3D environment containing the first virtual object and the second virtual object which is generated in response to a combination of the first and second prompts from different users may include or be embedded with a digital signature generated by digital signature generator 7350 which is associated with the first and second users.

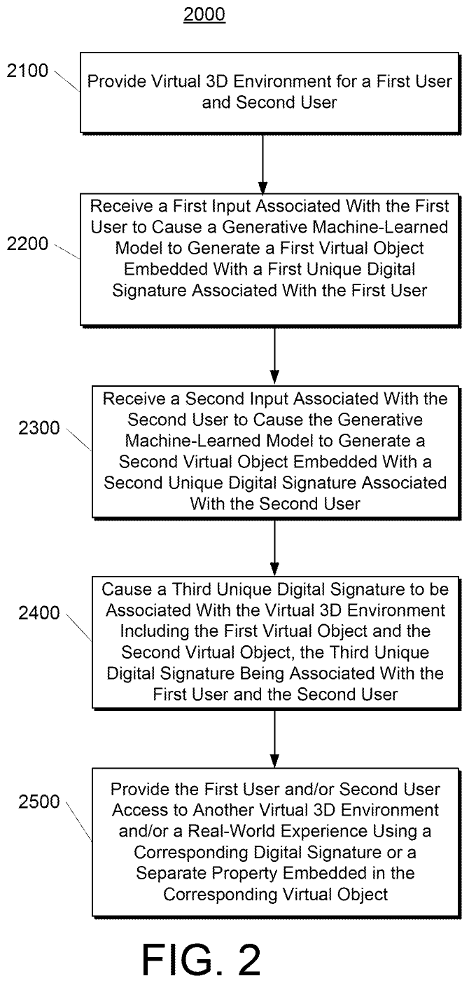

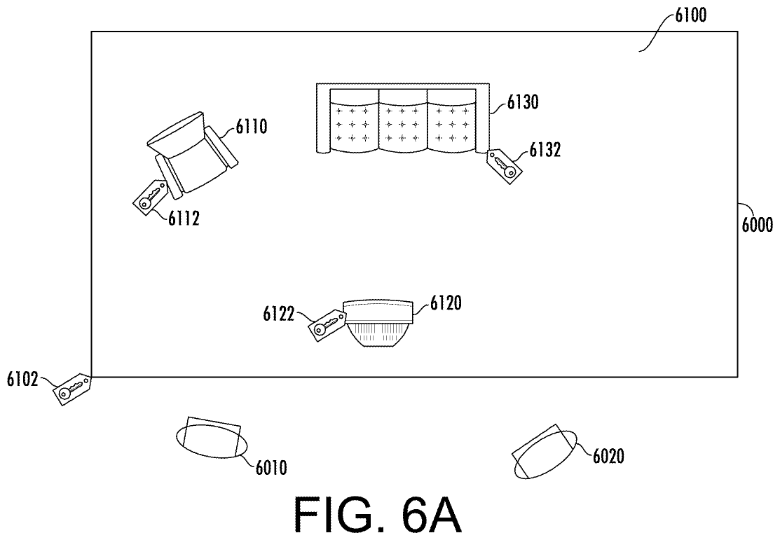

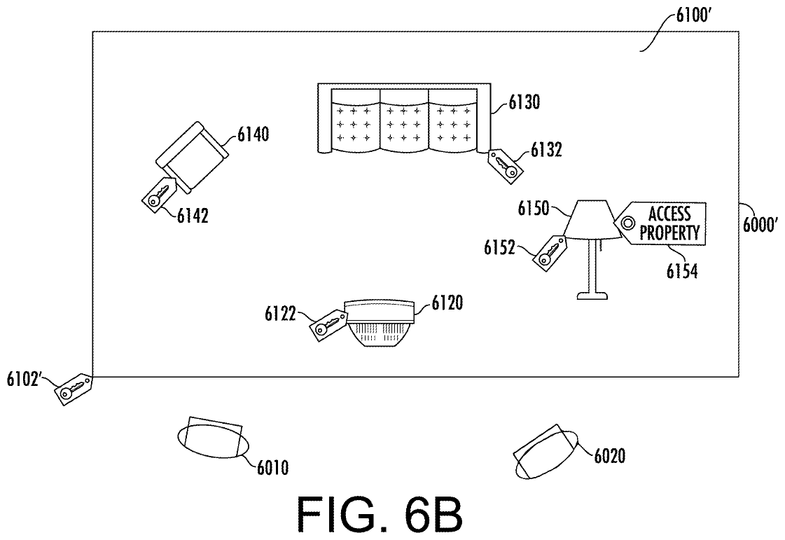

As will be explained below, FIGS. 2 through 5 describe further details regarding operations of the server computing system 7300 for generating content in connection with the one or more extended reality applications 7330. FIGS. 6A-6B describe example virtual environments for creating content according to one or more example embodiments of the disclosure. FIGS. 7A-7B describe example systems for creating content according to one or more example embodiments of the disclosure.

Methods 2000, 3000, 4000, and 5000 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, operations of the methods 2000, 3000, 4000, and 5000 are performed by the one or more extended reality applications 7330, one or more generative machine-learned models 7340, and digital signature generator 7350 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

Referring again to the drawings, FIG. 2 illustrates an example flow diagram of a non-limiting computer-implemented method according to one or more example embodiments of the disclosure.

In FIG. 2, method 2000 includes an operation 2100 of the server computing system 7300 providing a virtual 3D environment for a first user associated with the first computing device 7100 and a second user associated with the second computing device 7200. For example, the virtual 3D environment may be a virtual reality environment, an augmented reality environment, and the like. The first user and the second user may simultaneously view the virtual 3D environment via computing devices associated with the first and second users. For example, the first user and the second user may each be wearing virtual reality goggles and be fully immersed in the same virtual 3D environment at the same time via a virtual reality application which is executed at a computing device associated with the respective pair of virtual reality goggles. More specifically, the first computing device 7100 may be associated with the first user and may correspond to virtual reality goggles or may be connected to the virtual reality goggles (e.g., in a wireless and/or wired manner). The first computing device 7100 may execute one or more extended reality applications 7130 at the first computing device 7100 or may access one or more extended reality applications 7330 provided by the server computing system 7300 so that the virtual 3D environment is provided for viewing by the first user via the virtual reality goggles worn by the first user. Likewise, the second computing device 7200 may be associated with the second user and may correspond to virtual reality goggles or may be connected to the virtual reality goggles (e.g., in a wireless and/or wired manner). The second computing device 7200 may be configured in a manner similar to the first computing device 7100 and execute an extended reality application at the second computing device 7200 or may access one or more extended reality applications 7330 provided by the server computing system 7300 so that the virtual 3D environment is provided for viewing by the second user via the virtual reality goggles worn by the second user.

At operation 2200, the method 2000 includes receiving (e.g., by the server computing system 7300), a first input associated with the first user, to cause a generative machine-learned model to generate a first virtual object within the virtual 3D environment, the first virtual object being embedded with a first unique digital signature associated with the first user. For example, the first user may provide a prompt or input via input device 7150 which is transmitted from the first computing device 7100 to the server computing system 7300. The prompt or input may be a command or natural language input to request for certain content to be generated or to be modified, for example. With reference to FIG. 6A, in a first virtual 3D environment 6000 simultaneously viewed and shared by first user 6010 and second user 6020, the first user 6010 may provide a prompt (first input) requesting the one or more virtual reality applications 7132 or one or more virtual reality applications 7332 to “generate a living room having a chair, a television, and a couch.” In response to receiving the prompt, the virtual reality application 7132 or virtual reality application 7332 may communicate with one or more generative machine-learned models 7340 to generate a virtual 3D environment corresponding to the living room 6100 which includes virtual objects including a chair 6110, a television 6120, and a couch 6130. In this example, the prompt provided by the first user 6010 is generic and requests general objects without personalized information or further context. The one or more generative machine-learned models 7340 may be configured to generate the first virtual 3D environment 6000 based on deep learning algorithms that learn patterns and features from large datasets of images to create images (virtual objects) which resemble or represent the chair 6110, television 6120, and couch 6130. The one or more generative machine-learned models 7340 may not reference user data associated with the first user 6010 in generating the virtual objects, for example.

The server computing system 7300 (e.g., virtual reality application 7332) may be configured to also embed digital signatures generated by digital signature generator 7350 with each of the virtual objects and with the virtual 3D environment as a whole. For example, each of the items or features generated based on the prompt provided by the first user 6010 may be embedded with a unique digital signature which is associated with the first user 6010 who caused or requested that the virtual objects and the virtual 3D environment be created. For example, in FIG. 6A chair 6110 may be embedded with a first digital signature 6112 associated with the first user 6010, television 6120 may be embedded with a second digital signature 6122 associated with the first user 6010, and couch 6130 may be embedded with a third digital signature 6132 associated with the first user 6010. In addition, the living room 6100 or the first virtual 3D environment 6000 may be embedded with a fourth digital signature 6102 associated with the first user 6010. The digital signatures may be unique and may be in the form of a digital token, for example a non-fungible token. The digital signatures may be generated by digital signature generator 7350 and can represent ownership of a respective virtual object or of a respective virtual 3D environment created by a user or a plurality of users.

At operation 2300, the method 2000 includes receiving (e.g., by the server computing system 7300), a second input associated with the second user, to cause the generative machine-learned model to generate a second virtual object within the virtual 3D environment, the second virtual object being generated based on the second input and contextual information associated with the second user and the second virtual object being embedded with a unique digital signature associated with the second user. For example, the second user may provide a prompt or input via an input device (similar to input device 7150) which is transmitted from the second computing device 7200 to the server computing system 7300. The prompt or input may be a command or natural language input to request for certain content to be generated or to be modified, for example. With reference to FIG. 6B, in a second virtual 3D environment 6000′ simultaneously viewed and shared by first user 6010 and second user 6020, the second user 6020 may provide a prompt (second input) requesting a virtual reality application associated with the second computing device 7200 or virtual reality application 7332 to “generate a lamp similar to the one in my living room and make the chair have a mid-century design.” In response to receiving the prompt, the virtual reality application associated with the second computing device 7200 or virtual reality application 7332 may communicate with one or more generative machine-learned models 7340 to generate the second virtual 3D environment 6000′ corresponding to the living room 6100′ which includes virtual objects including the previously generated television 6120 and couch 6130, and the mid-century chair 6140 and lamp 6150. In this example, the prompt provided by the second user 6020 is not generic and requests objects with some personalized information or further context. The one or more generative machine-learned models 7340 may be configured to generate the first virtual 3D environment 6000 based on deep learning algorithms that learn patterns and features from large datasets of images to create images (virtual objects) based on the content of the prompt itself as well as based on further contextual information which may be obtained from external sources, user data associated with the second user 6020, etc. For example, the one or more generative machine-learned models 7340 may reference (with appropriate permissions and consent) user data associated with the second user 6020 in generating the virtual objects. As an example, the one or more generative machine-learned models 7340 may reference user data store 7370 (see FIG. 7BA) to determine whether images of the living room of the second user 6020 depict a lamp for generating the lamp 6150, the one or more generative machine-learned models 7340 may reference user data store 7370 to determine a favorite color of the second user 6020 in selecting a color for the lamp 6150, the one or more generative machine-learned models 7340 may reference images of the living room of the second user 6020 to determine a style preferred by the second user 6020 when images of a lamp are not depicted in the living room of the second user 6020 to generate a lamp having a particular style, etc. As an example, the one or more generative machine-learned models 7340 may reference external content 7500 (see FIG. 7BA) to retrieve images of chairs described or annotated as having a mid-century design for generating the chair 6140, the one or more generative machine-learned models 7340 may reference user data store 7370 to determine whether the second user 6020 has a favorite designer from a time period relevant to mid-century furniture design for generating the chair 6140, etc.

The server computing system 7300 (e.g., virtual reality application 7332) may be configured to also embed digital signatures generated by digital signature generator 7350 with each of the virtual objects and with the virtual 3D environment as a whole. For example, each of the items or features generated based on the prompt provided by the second user 6020 may be embedded with a unique digital signature which is associated with the second user 6020 who caused or requested that certain virtual objects and the modified virtual 3D environment be created. For example, in FIG. 6B chair 6140 may be embedded with a fifth digital signature 6142 associated with the second user 6020, television 6120 may be embedded with the second digital signature 6122 associated with the first user 6010, couch 6130 may be embedded with the third digital signature 6132 associated with the first user 6010, and lamp 6150 may be embedded with a sixth digital signature 6152 associated with the second user 6020. The digital signatures may be unique and may be in the form of a digital token, for example a non-fungible token. The digital signatures may be generated by digital signature generator 7350 and can represent ownership of a respective virtual object or of a respective virtual 3D environment created by a user or a plurality of users.

At operation 2400, the method 2000 includes causing a unique digital signature to be associated with the virtual 3D environment including virtual object(s) created by a first user and virtual object(s) created by a second user, the unique digital signature being associated with the first user and the second user. The unique digital signature may be in the form of a digital token, for example a non-fungible token. For example, the unique digital signature may be generated by digital signature generator 7350 and can represent ownership of a respective virtual 3D environment created by a plurality of users. Referring again to FIG. 6B, the modified living room 6100′ or the second virtual 3D environment 6000′ may be embedded with a seventh digital signature 6102′ associated with both the first user 6010 and the second user 6020.

At operation 2500, the method 2000 includes providing a first user and/or a second user access to another virtual 3D environment and/or a real-world experience using a corresponding digital signature or a separate property embedded in a corresponding virtual object created by a respective user. For example, in response to generating the lamp 6150, access generator 7360 (see FIG. 7BB) may be configured to provide access to the second user 6020 to another virtual 3D environment and/or real-world experience using the sixth digital signature 6152 or using a separate property embedded with the second virtual object (e.g., access property 6154 shown in FIG. 6B). The separate property may be another digital signature that allows access to the other virtual 3D environment and/or real-world experience, a digital utility token, etc.

In some implementations, in conjunction with the creation of the virtual objects within the virtual 3D environment based on the collaborative effort of the first and second users, each virtual object and/or each version of a virtual object, as well as the virtual 3D environment containing the virtual object(s), may be embedded with a property (e.g., a digital utility token), that enables a user to access another digital space or access an experience in the real-world. In some implementations, the server computing system 7300 may embed a virtual object with the property or digital utility token (e.g., via digital signature generator 7350 and/or access generator 7360) based on characteristics of the virtual object and/or based on the content of the prompt input by the user. In the context of the example of FIG. 6B, when chair 6110 has been modified or replaced by chair 6140 based on the input provided by the second user 6020 to cause the chair 6140 to be generated with a mid-century design, the access generator 7360 may determine an appropriate virtual and/or real-world experience for the second user 6020 such that the generated property or digital utility token may enable the second user 6020 to gain access to a virtual conference in which 1950s furniture design is discussed. As another example, the property or digital utility token may enable the second user 6020 to obtain a discount at a furniture store, gain access to a furniture store outside of normal business hours for a sale, and the like. For example, to obtain access to a digital space or experience (e.g., the virtual conference, the discount, physical access to the furniture store, etc.) ownership of the digital utility token may be transferred to an entity which provides the access to the digital space or experience. As another example, entry to a digital space or experience (e.g., the virtual conference, the discount, physical access to the furniture store, etc.) may be mapped by the access generator 7360 to a unique identifier associated with the digital utility token such that when the digital token is presented to an entity which provides the access to the digital space or experience, the entity grants access to the user. In some implementations, the property or digital utility token may correspond to the digital signature that is embedded with the virtual object when the virtual object is created or generated by the one or more generative machine-learned models 7340.

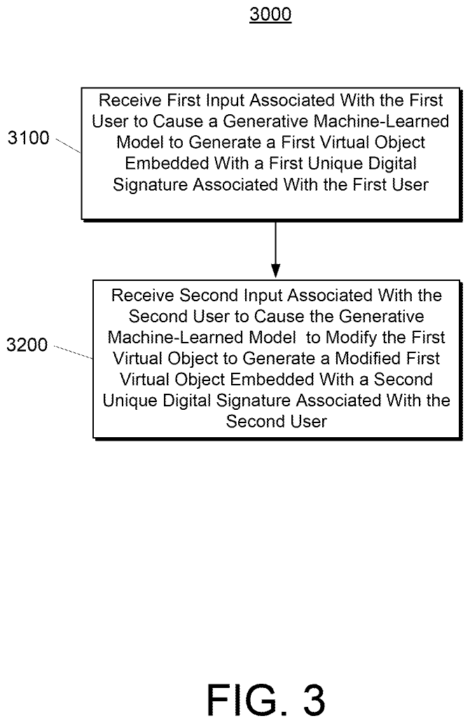

FIGS. 3 through 5 illustrate example flow diagrams of non-limiting computer-implemented methods, according to one or more example embodiments of the disclosure. As explained above, a user can request the extended reality applications 7330 to generate a virtual object or to modify an existing virtual object provided in the virtual 3D environment.

In FIG. 3, method 3000 includes an operation 3100 of receiving (e.g., by the server computing system 7300), a first input associated with the first user, to cause a generative machine-learned model to generate a first virtual object within the virtual 3D environment, the first virtual object being embedded with a first unique digital signature associated with the first user. Operation 3100 is similar to operation 2200 of FIG. 2 and therefore a detailed discussion of this operation will not be repeated for the sake of brevity.

At operation 3200, the method 3000 includes receiving (e.g., by the server computing system 7300), a second input associated with the second user, to cause the generative machine-learned model to modify the first virtual object within the virtual 3D environment, to generate a modified first virtual object. The modified first virtual object is generated based on the second input and contextual information associated with the second user and the second virtual object is embedded with a unique digital signature associated with the second user. For example, the second user may provide a prompt or input via an input device (similar to input device 7150) which is transmitted from the second computing device 7200 to the server computing system 7300. The prompt or input may be a command or natural language input to request for the first virtual object to be modified, for example. Referring back to FIG. 6B for example, in the second virtual 3D environment 6000′ simultaneously viewed and shared by first user 6010 and second user 6020, the second user 6020 may provide a prompt (second input) requesting a virtual reality application associated with the second computing device 7200 or virtual reality application 7332 to modify the chair 6110 of FIG. 6A which was generated based on an input by the first user 6010. For example, the second user 6020 may provide an input such as “make the chair have a mid-century design” or “make the chair blue.” In response to receiving the prompt, the virtual reality application associated with the second computing device 7200 or virtual reality application 7332 may communicate with one or more generative machine-learned models 7340 to modify the chair 6110 and generate a modified chair corresponding to chair 6140 in FIG. 6B. The one or more generative machine-learned models 7340 may be configured to generate the chair 6140 based on deep learning algorithms that learn patterns and features from large datasets of images to create images (virtual objects) based on the content of the prompt itself as well as based on further contextual information which may be obtained from external sources, user data associated with the second user 6020, etc. For example, the one or more generative machine-learned models 7340 may reference (with appropriate permissions and consent) user data associated with the second user 6020 in generating the chair 6140. As an example, the one or more generative machine-learned models 7340 may reference user data store 7370 (see FIG. 7BA) to determine a favorite shade of blue of the second user 6020, the one or more generative machine-learned models 7340 may reference images of the living room of the second user 6020 to determine a style preferred by the second user 6020, the one or more generative machine-learned models 7340 may reference external content 7500 (see FIG. 7BA) to retrieve images of chairs described or annotated as having a mid-century design for generating the chair 6140, the one or more generative machine-learned models 7340 may reference user data store 7370 to determine whether the second user 6020 has a favorite designer from a time period relevant to mid-century furniture design for generating the chair 6140, etc.

The server computing system 7300 (e.g., virtual reality application 7332) may be configured to also embed a digital signature generated by digital signature generator 7350 with the modified virtual object. For example, in FIG. 6B chair 6140 may be embedded with the fifth digital signature 6142 associated with the second user 6020 as discussed above. The digital signature may be unique and may be in the form of a digital token, for example a non-fungible token. The digital signature may be generated by digital signature generator 7350 and can represent ownership of the chair 6140 created by the second user 6020. In some implementations, the server computing system 7300 may be configured to retain an original or prior versions of virtual objects in memory (e.g., the one or more memory devices 7320) when a virtual object is modified or replaced or when the virtual environment is changed. In some implementations, the server computing system 7300 may be configured to delete original or prior versions of a virtual object or of a virtual environment when a virtual object is modified or replaced or when the virtual environment is changed, to save computing resources. For example, the server computing system 7300 may be configured to retain the chair 6110 and corresponding first digital signature 6112 in memory (e.g., the one or more memory devices 7320), or the chair 6110 and corresponding first digital signature 6112 may be deleted to save computing resources.

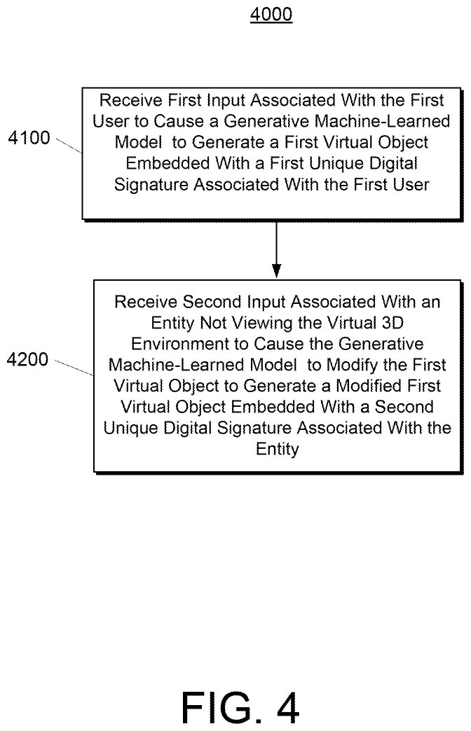

In FIG. 4, method 4000 includes an operation 4100 of receiving (e.g., by the server computing system 7300), a first input associated with the first user, to cause a generative machine-learned model to generate a first virtual object within the virtual 3D environment, the first virtual object being embedded with a first unique digital signature associated with the first user. Operation 4100 is similar to operation 2200 of FIG. 2 and therefore a detailed discussion of this operation will not be repeated for the sake of brevity.

At operation 4200, the method 4000 includes receiving (e.g., by the server computing system 7300), a second input associated with an entity not viewing the virtual 3D environment, to cause the generative machine-learned model to modify the first virtual object within the virtual 3D environment, to generate a modified first virtual object. The modified first virtual object is generated based on the second input and contextual information associated with the entity and the second virtual object is embedded with a unique digital signature associated with the entity. For example, the second user may provide a prompt or input via an input device (similar to input device 7150) which is transmitted from the second computing device 7200 to the server computing system 7300. The prompt or input may be a command or natural language input to request for the first virtual object to be modified, for example, based on the creation of an entity that is not participating in the shared virtual 3D environment. Referring back to FIG. 6B for example, in the second virtual 3D environment 6000′ simultaneously viewed and shared by first user 6010 and second user 6020, the second user 6020 may provide a prompt (second input) requesting a virtual reality application associated with the second computing device 7200 or virtual reality application 7332 to modify the chair 6110 of FIG. 6A which was generated based on an input by the first user 6010. For example, the second user 6020 may provide an input such as “make the chair look like the womb chair by Eero Saarinen.” In response to receiving the prompt, the virtual reality application associated with the second computing device 7200 or virtual reality application 7332 may communicate with one or more generative machine-learned models 7340 to modify the chair 6110 and generate a modified chair corresponding to chair 6140 in FIG. 6B. The one or more generative machine-learned models 7340 may be configured to generate the chair 6140 based on deep learning algorithms that learn patterns and features from large datasets of images to create images (virtual objects) based on the content of the prompt itself as well as based on further contextual information which may be obtained from external sources, user data associated with the second user 6020, etc. For example, the one or more generative machine-learned models 7340 may reference external content 7500 (see FIG. 7BA) to retrieve images of chairs described or annotated as the “womb chair” by mid-century designer “Eero Saarinen.”

In the above-example, the server computing system 7300 (e.g., virtual reality application 7332 and/or the one or more generative machine-learned models 7340) may be configured to recognize that Eero Saarinen is an entity which is not participating or viewing the virtual 3D environment. However, the digital signature generator 7350 may be configured to embed a digital signature with the modified virtual object which is associated with Eero Saarinen. For example, in FIG. 6B chair 6140 may be embedded with the fifth digital signature 6142 associated with the entity Eero Saarinen which provides attribution to the designer of the chair 6140 which is represented in the second virtual 3D environment 6000′. In some implementations, the fifth digital signature 6142 may be associated with the entity Eero Saarinen as well as the second user 6020 which requested the virtual object to be generated. The server computing system 7300 (e.g., virtual reality application 7332 and/or the one or more generative machine-learned models 7340) may be configured to associate a digital signature embedded with a modified virtual object with an entity not simultaneously viewing the virtual 3D environment with a plurality of users based on contextual information without the entity being expressly named in the prompt. For example, if the second user 6020 provided an input such as “make the chair look like the womb chair,” the one or more generative machine-learned models 7340 may reference external content 7500 (see FIG. 7BA) to retrieve images of chairs described or annotated as the “womb chair” and determine that the “womb chair” was designed by mid-century designer Eero Saarinen. Therefore, the chair 6140 may be embedded with the fifth digital signature 6142 and associated with the entity Eero Saarinen which provides attribution to the designer of the chair 6140 which is represented in the second virtual 3D environment 6000′.

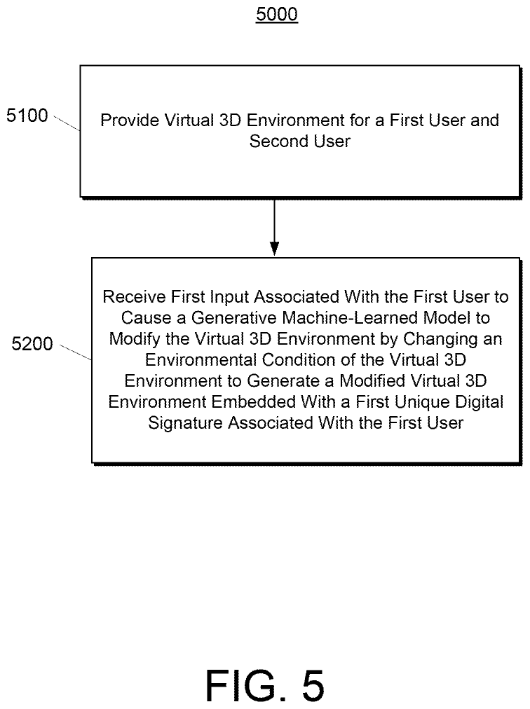

In FIG. 5, method 5000 includes an operation 5100 of providing a virtual 3D environment (e.g., by the server computing system 7300), for a first user and a second user. Operation 5100 is similar to operation 2100 of FIG. 2 and therefore a detailed discussion of this operation will not be repeated for the sake of brevity.

At operation 5200, the method 5000 includes receiving (e.g., by the server computing system 7300), the method 2000 includes receiving (e.g., by the server computing system 7300), a first input associated with the first user, to cause a generative machine-learned model to modify the virtual 3D environment by changing an environmental condition of the virtual 3D environment to generate a modified virtual 3D environment. The modified virtual 3D environment may be embedded with a first unique digital signature associated with the first user. For example, the first user may provide a prompt or input via input device 7150 which is transmitted from the first computing device 7100 to the server computing system 7300. The prompt or input may be a command or natural language input to request for an environment condition of the virtual 3D environment to be modified, for example. For example, the environmental condition may include one more of a lighting condition of the virtual 3D environment, a weather condition of the virtual 3D environment, a noise condition of the virtual 3D environment, a time of day in the virtual 3D environment, or a geographic location of the virtual 3D environment. For example, a first virtual 3D environment simultaneously viewed and shared by a first user and a second user 6020 may be a beach scene along the Mediterranean coast that may be a default virtual environment generated by the one or more extended reality applications 7330 or requested previously by another user. The first user 6010 may provide a prompt (first input) requesting the one or more virtual reality applications 7132 or one or more virtual reality applications 7332 to “have there be a thunderstorm” or “have there be a light rain,” or “have it be at sunset.” In response to receiving the prompt, the one or more virtual reality applications 7132 or one or more virtual reality applications 7332 may communicate with one or more generative machine-learned models 7340 to generate a virtual 3D environment corresponding to the prompt. The one or more generative machine-learned models 7340 may be configured to generate the modified virtual 3D environment based on deep learning algorithms that learn patterns and features from large datasets of images to create images which resemble or represent the Mediterranean coast having the features indicated by the first user. In some implementations, the one or more generative machine-learned models 7340 may not reference user data associated with the first user in generating the modified virtual environment, for example. In some implementations, the one or more generative machine-learned models 7340 may reference user data (with appropriate permissions and user consent) associated with the first user in generating the modified virtual environment. For example, the one or more generative machine-learned models 7340 may select particular hues or colors for generating the sunset that are more likely to be appealing to the first user.

The server computing system 7300 (e.g., virtual reality application 7332) may be configured to also embed a digital signature generated by digital signature generator 7350 with the modified virtual 3D environment which is associated with the first user. The digital signature may be unique and may be in the form of a digital token, for example a non-fungible token. The digital signature may be generated by digital signature generator 7350 and can represent ownership of the modified virtual 3D environment created by the user (or a plurality of users as the case may be). Similar to the example of FIG. 4, where the prompt includes contextual information that indicates the virtual 3D environment is to be modified based on an entity not viewing the virtual 3D environment, the digital signature may also be associated with the entity when the digital signature is embedded with the modified virtual 3D environment (in addition to the first user or instead of the first user). For example, if the first user requests a sunset that is “like the one in The Scream” then the digital signature may be associated with the artist Edvard Munch when the digital signature is embedded with the modified virtual 3D environment (in addition to the first user or instead of the first user).

FIGS. 7A and 7B are example systems according to examples of the disclosure which provide an overview of example systems that may be employed to implement the methods described herein for providing a collaborative creation space (e.g., a three-dimensional virtual environment) for a plurality of users through which content can be created via prompts provided by the plurality of users using one or more generative machine-learned models.

FIG. 7A is an example system according to one or more example embodiments of the disclosure. FIG. 7A illustrates an example of a system 7000 which includes a first computing device 7100, a second computing device 7200, a server computing system 7300, and external content 7500, which may be in communication with one another over a network 7400. For example, the first computing device 7100 and the second computing device 7200 can include any of a personal computer, a smartphone, a tablet computer, a global positioning service device, a smartwatch, and the like. The network 7400 may include any type of communications network including a wired or wireless network, or a combination thereof. The network 7400 may include a local area network (LAN), wireless local area network (WLAN), wide area network (WAN), personal area network (PAN), virtual private network (VPN), or the like. For example, wireless communication between elements of the example embodiments may be performed via a wireless LAN, Wi-Fi, Bluetooth, ZigBee, Wi-Fi direct (WFD), ultra wideband (UWB), infrared data association (IrDA), Bluetooth low energy (BLE), near field communication (NFC), a radio frequency (RF) signal, and the like. For example, wired communication between elements of the example embodiments may be performed via a pair cable, a coaxial cable, an optical fiber cable, an Ethernet cable, and the like. Communication over the network can use a wide variety of communication protocols (e.g., TCP/IP, HTTP, SMTP, FTP), encodings or formats (e.g., HTML, XML), and/or protection schemes (e.g., VPN, secure HTTP, SSL).

As explained herein, in some implementations the first computing device 7100, second computing device 7200, and/or server computing system 7300 may form part of an extended reality system where users can collaborate in a shared space to create content via prompts or inputs provided by the plurality of users using one or more generative machine-learned models.

In some example embodiments, the server computing system 7300 may obtain data from a user data store 7370, to implement various operations and aspects of the extended reality system as disclosed herein. The user data store 7370 may be integrally provided with the server computing system 7300 (e.g., as part of the one or more memory devices 7320 of the server computing system 7300) or may be separately (e.g., remotely) provided. Further, user data store 7370 can be combined as a single data store (database) or may be a plurality of respective data stores corresponding to respective users. Data stored in one data store may overlap with some data stored in another data store. In some implementations, one data store may reference data that is stored in another data store.

The user data store 7370 is provided to illustrate potential data that could be analyzed, in some embodiments, by the server computing system 7300 to identify user preferences, for example user preferences in the context of generating content in a virtual 3D environment. For example, the user data store may include user preferences with respect to generating content by the one or more generative machine-learned models 7340 to be taken in response to receiving an input from a user. User data may not be collected, used, or analyzed unless the user has consented after being informed of what data is collected and how such data is used. Further, in some embodiments, the user can be provided with a tool (e.g., via a user account) to revoke or modify the scope of permissions. In addition, certain information or data can be treated in one or more ways before it is stored or used, so that personally identifiable information is removed or stored in an encrypted fashion. Thus, particular user information stored in the user data store 7370 may or may not be accessible to the server computing system 7300 based on permissions given by the user, or such data may not be stored in the user data store 7370 at all.

External content 7500 can be any form of external content including news articles, webpages, video files, audio files, written descriptions, ratings, game content, social media content, photographs, commercial offers, transportation method, weather conditions, sensor data obtained by various sensors, or other suitable external content. The first computing device 7100, second computing device 7200, and server computing system 7300 can access external content 7500 over network 7400. External content 7500 can be searched by first computing device 7100, second computing device 7200, and server computing system 7300 according to known searching methods and search results can be ranked according to relevance, popularity, or other suitable attributes. For example, the server computing system 7300 (e.g., virtual reality applications 7332 and/or generative machine-learned models 7340) may reference external content 7500 to generate content (e.g., virtual 3D environments, virtual objects, sounds, etc.) in response to a request or prompt from a user.

FIG. 7B illustrates more detailed example block diagrams of the first computing device and server computing system, according to one or more example embodiments of the disclosure will now be described. Although first computing device 7100 is represented in the system 7000′ shown in FIG. 7B, features of the first computing device 7100 described herein are also applicable to the second computing device 7200.

The first computing device 7100 may include one or more processors 7110, one or more memory devices 7120, one or more extended reality applications 7130, an input device 7150, a display device 7160, and an output device 7170. The server computing system 7300 may include one or more processors 7310, one or more memory devices 7320, one or more extended reality applications 7330, one or more generative machine-learned models 7340, a digital signature generator 7350, and an access generator 7360.

For example, the one or more processors 7110, 7310 can be any suitable processing device that can be included in a first computing device 7100 or server computing system 7300. For example, the one or more processors 7110, 7310 may include one or more of a processor, processor cores, a controller and an arithmetic logic unit, a central processing unit (CPU), a graphics processing unit (GPU), a digital signal processor (DSP), an image processor, a microcomputer, a field programmable array, a programmable logic unit, an application-specific integrated circuit (ASIC), a microprocessor, a microcontroller, etc., and combinations thereof, including any other device capable of responding to and executing instructions in a defined manner. The one or more processors 7110, 7310 can be a single processor or a plurality of processors that are operatively connected, for example in parallel.

The one or more memory devices 7120, 7320 can include one or more non-transitory computer-readable storage mediums, including a Read Only Memory (ROM), Programmable Read Only Memory (PROM), Erasable Programmable Read Only Memory (EPROM), and flash memory, a USB drive, a volatile memory device including a Random Access Memory (RAM), a hard disk, floppy disks, a blue-ray disk, or optical media such as CD ROM discs and DVDs, and combinations thereof. However, examples of the one or more memory devices 7120, 7320 are not limited to the above description, and the one or more memory devices 7120, 7320 may be realized by other various devices and structures as would be understood by those skilled in the art.

For example, the one or more memory devices 7120 can store instructions, that when executed, cause the one or more processors 7110 to execute one or more extended reality applications 7130 (e.g., one or more virtual reality applications 7132, one or more augmented reality applications 7134, and the like). For example, the one or more extended reality applications 7130 may receive an input (e.g., a text input, a voice input, etc.) which includes a prompt or request from a user associated with the first computing device 7100 for generating content (e.g., a virtual object) in the virtual 3D environment provided via the one or more extended reality applications 7130. The input may be received by the input device 7150 for example and transmitted to the server computing system 7300, as described according to examples of the disclosure.

One or more memory devices 7120 can also include data 7122 and instructions 7124 that can be retrieved, manipulated, created, or stored by the one or more processors 7110. In some example embodiments, such data can be accessed and used as input to implement one or more extended reality applications 7130, and to transmit an input (e.g., a request for a virtual object to be generated, a request for an environmental condition of the virtual 3D environment to be changed, etc.) to the server computing system 7300.

For example, the one or more memory devices 7320 can store instructions, that when executed, cause the one or more processors 7310 to execute one or more extended reality applications 7330 (e.g., one or more virtual reality applications 7132, one or more augmented reality applications 7134, and the like). For example, the one or more extended reality applications 7330 may receive an input which is transmitted from the first computing device 7100 to the server computing system 7300. The input may include a prompt (e.g., in the form of a text input, voice input, etc.) to generate or modify content (e.g., a virtual object), as described according to examples of the disclosure.

One or more memory devices 7320 can also include data 7322 and instructions 7324 that can be retrieved, manipulated, created, or stored by the one or more processors 7310. In some example embodiments, such data can be accessed and used as input to implement one or more extended reality applications 7330, to generate or modify content (e.g., via the one or more generative machine-learned models 7340), to generate one or more digital signatures (e.g., via digital signature generator 7350), and to provide access to other virtual environments and/or real-world experiences (e.g., via access generator 7360).

The first computing device 7100 may include an input device 7150 configured to receive an input from a user and may include, for example, one or more of a keyboard (e.g., a physical keyboard, virtual keyboard, etc.), a mouse, a joystick, a button, a switch, an electronic pen or stylus, a gesture recognition sensor (e.g., to recognize gestures of a user including movements of a body part), an input sound device or speech recognition sensor (e.g., a microphone to receive a voice input such as a voice command or a voice query), a track ball, a remote controller, a portable (e.g., a cellular or smart) phone, a tablet PC, a pedal or footswitch, a virtual-reality device, an augmented-reality device, and so on. The input device 7150 may also be embodied by a touch-sensitive display having a touchscreen capability, for example. For example, the input device 7150 may be configured to receive an input from a user associated with the input device 7150. For example, the input may include an input to one or more of the one or more extended reality applications 7130.

The first computing device 7100 may include a display device 7160 which displays information viewable by the user (e.g., a user interface screen). For example, the display device 7160 may be a non-touch sensitive display or a touch-sensitive display. The display device 7160 may include a liquid crystal display (LCD), a light emitting diode (LED) display, an organic light emitting diode (OLED) display, active matrix organic light emitting diode (AMOLED), flexible display, 3D display, a plasma display panel (PDP), a cathode ray tube (CRT) display, and the like, for example. However, the disclosure is not limited to these example displays and may include other types of displays. The display device 7160 can be used by the one or more extended reality applications 7130 installed on the first computing device 7100 to display information or provide a user interface screen to a user which is capable of receiving an input. The display device 7160 can be used by the one or more extended reality applications 7130 installed on the first computing device 7100 to display a virtual 3D environment.

The first computing device 7100 may include an output device 7170 to provide an output to the user and may include, for example, one or more of an audio device (e.g., one or more speakers), a haptic device to provide haptic feedback to a user (e.g., a vibration device), a light source (e.g., one or more light sources such as LEDs which provide visual feedback to a user), a thermal feedback system, and the like.

In accordance with example embodiments described herein, the server computing system 7300 can include one or more processors 7310 and one or more memory devices 7320 which were previously discussed above. The server computing system 7300 may also include the one or more extended reality applications 7330, the one or more generative machine-learned models 7340, the digital signature generator 7350, and the access generator 7360, previously discussed herein. In some implementations, the first computing device 7100 and/or the second computing device 7200 may also include similar features and/or perform similar functions as the server computing system 7300, including the features of the one or more generative machine-learned models 7340, the digital signature generator 7350, and the access generator 7360, previously discussed herein. Therefore, in some implementations, one or more generative machine-learned models 7340, the digital signature generator 7350, and the access generator 7360 may be provided in a computing device, for example, first computing device 7100 and/or second computing device 7200, and aspects of the one or more generative machine-learned models 7340, the digital signature generator 7350, and the access generator 7360 described in the context of the server computing system 7300 are also applicable to the first computing device 7100 and second computing device 7200.

The one or more extended reality applications 7330 may be configured to provide one or more virtual 3D environments to a user associated with a computing device. For example, the one or more extended reality applications 7330 may include one or more virtual reality applications 7332, one or more augmented reality applications 7334, and the like. The virtual 3D environment provided via the one or more virtual reality applications 7332 or the one or more augmented reality applications 7334 may be simultaneously viewed by a plurality of users who are immersed in the virtual 3D environment. For example, the virtual 3D environment may be associated with a gaming environment, a simulation environment (e.g., aviation, medicine, etc.), education and training environment, an art and design environment, and the like.

The one or more generative machine-learned models 7340 may be implemented by the one or more extended reality applications 7330 to generate content within the virtual 3D environment. The one or more generative machine-learned models 7340 may be configured to generate a virtual 3D environment based on deep learning algorithms that learn patterns and features from large datasets of images to create images (e.g., virtual objects) or sounds or other content based on the content of a prompt, based on contextual information associated with a user, based on contextual information obtained from external sources, and the like. For example, contextual information associated with a user or entity may be obtained based on at least one of a user profile associated with the user or entity, preferences associated with the user or entity, or information about the user or entity obtained from an external source. An example generative machine-learned model includes a generative adversarial network (GAN). GAN is a type of neural network architecture that includes two sub-models including a generator and a discriminator. The GAN model GAN model can be implemented to generate images, videos, and sound (e.g., music), for example. Another example generative machine-learned model includes the DALL-E artificial intelligence program which can generate images from text inputs by using one or more algorithms to generate an image that matches the description provided in the text input, using a contrastive learning process. Other generative machine-learned models (or generative AI tools) may be implemented to generate content including text, imagery, sound (music, voices, etc.), and the like (e.g., JASPER, AMPER, etc.).

The digital signature generator 7350 may be configured to generate and embed one or more digital signatures with content generated by the one or more generative machine-learned models 7340. For example, the digital signature may include a private key that encrypts a hash value of a corresponding virtual object. As another example, a virtual object (or other content) may include or be embedded with a unique identifier (UID) generated by the digital signature generator 7350 that is assigned to a corresponding user or entity which indicates ownership or possible ownership rights with respect to the virtual object created based on the prompt provided by the user. As another example, a virtual object (or other content) may include or be embedded with a digital token (e.g., a non-fungible token) generated by digital signature generator 7350 that indicates ownership or possible ownership rights with respect to the virtual object by a user and/or entity who caused the virtual object to be created based on the prompt provided by the user. The digital token may be issued (e.g., using blockchain or other distributed ledger technology) by a trusted authority (e.g., the server computing system 7300) and can be stored and transferred securely using blockchain or other distributed ledger technology. For example, ownership of an NFT or other digital token can be transferred through the blockchain, and the transaction history may be stored on the ledger, providing a transparent and immutable record of ownership. In some implementations, the digital signature or digital token may be issued by an entity other than the server computing system 7300 (e.g., by an organization, governmental entity, a company, through a decentralized application, by an individual, etc.).

The access generator 7360 may be configured to determine or identify an appropriate virtual experience and/or a real-world experience to provide access to a user based on at least one of an input associated with a user or based on contextual information associated with the user. For example, the access generator 7360 may issue a digital token when virtual content is created by a user, and the digital token may be associated with a virtual or real-world experience according to a type of content created by the user, according to the content of the prompt which caused the virtual content to be created, according to contextual information associated with the user, and the like. For example, the access generator 7360 may be configured to issue the digital token on behalf of another entity.

For example, in response to a user causing a virtual object representing a mid-century furniture piece to be generated, the access generator 7360 may be configured to issue a digital token on behalf of a store which specializes in selling mid-century furniture and the digital token may be embedded in the virtual object. The store may be able to verify the digital token to ensure its validity and provide access to the store, to a special sale or discount at the store, to free merchandise from the store, to early entry to the store, and the like.

For example, in response to a user causing a virtual object representing a mid-century furniture piece to be generated, the access generator 7360 may be configured to issue a digital token on behalf of organizers of a virtual conference which is to discuss mid-century furniture design and the digital token may be embedded in the virtual object. The organizers of the virtual conference may be able to verify the digital token to ensure its validity and provide access to the virtual conference which takes place in another virtual environment that may be provided by the one or more extended reality applications 7130.

The access generator 7360 can be configured to embed credentials other than digital tokens in the virtual object (or other virtual content) created by a user in the virtual 3D environment which can be used to verify that the user has permission to access a virtual or real-world experience associated with the virtual object. For example, a platform hosting or providing the virtual or real-world experience can verify the digital token or other credentials embedded within the virtual object to ensure that the user has permission to access the associated experience. Using digital tokens or other credentials embedded in virtual content to provide access to virtual experiences can provide a secure and efficient way to manage access to virtual or real-world experiences.

To the extent terms including “module”, and “unit,” and the like are used herein, these terms may refer to, but are not limited to, a software or hardware component or device, such as a Field Programmable Gate Array (FPGA) or Application Specific Integrated Circuit (ASIC), which performs certain tasks. A module or unit may be configured to reside on an addressable storage medium and configured to execute on one or more processors. Thus, a module or unit may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules/units may be combined into fewer components and modules/units or further separated into additional components and modules.

Aspects of the above-described example embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks, Blue-Ray disks, and DVDs; magneto-optical media such as optical discs; and other hardware devices that are specially configured to store and perform program instructions, such as semiconductor memory, read-only memory (ROM), random access memory (RAM), flash memory, USB memory, and the like. Examples of program instructions include both machine code, such as produced by a compiler, and files containing higher level code that may be executed by the computer using an interpreter. The program instructions may be executed by one or more processors. The described hardware devices may be configured to act as one or more software modules to perform the operations of the above-described embodiments, or vice versa. In addition, a non-transitory computer-readable storage medium may be distributed among computer systems connected through a network and computer-readable codes or program instructions may be stored and executed in a decentralized manner. In addition, the non-transitory computer-readable storage media may also be embodied in at least one application specific integrated circuit (ASIC) or Field Programmable Gate Array (FPGA).

Each block of the flowchart illustrations may represent a unit, module, segment, or portion of code, which comprises one or more executable instructions for implementing the specified logical function(s). It should also be noted that in some alternative implementations, the functions noted in the blocks may occur out of order. For example, two blocks shown in succession may in fact be executed substantially concurrently (simultaneously) or the blocks may sometimes be executed in the reverse order, depending upon the functionality involved.

Reference has been made to embodiments of the disclosure, one or more examples of which are illustrated in the drawings, wherein like reference characters denote like elements. Each example is provided by way of explanation of the disclosure and is not intended to limit the disclosure. In fact, it will be apparent to those skilled in the art that various modifications and variations can be made to disclosure without departing from the scope or spirit of the disclosure. For instance, features illustrated or described as part of one embodiment can be used with another embodiment to yield a still further embodiment. Thus, it is intended that the disclosure covers such modifications and variations as come within the scope of the appended claims and their equivalents.

Terms used herein are used to describe the example embodiments and are not intended to limit and/or restrict the disclosure. The singular forms “a,” “an” and “the” are intended to include the plural forms as well, unless the context clearly indicates otherwise. In this disclosure, terms such as “including”, “having”, “comprising”, and the like are used to specify features, numbers, steps, operations, elements, components, or combinations thereof, but do not preclude the presence or addition of one or more of the features, elements, steps, operations, elements, components, or combinations thereof.

It will be understood that, although the terms first, second, third, etc., may be used herein to describe various elements, the elements are not limited by these terms. Instead, these terms are used to distinguish one element from another element. For example, without departing from the scope of the disclosure, a first element may be termed as a second element, and a second element may be termed as a first element.

The term “and/or” includes a combination of a plurality of related listed items or any item of the plurality of related listed items. For example, the scope of the expression or phrase “A and/or B” includes the item “A”, the item “B”, and the combination of items “A and B”.

In addition, the scope of the expression or phrase “at least one of A or B” is intended to include all of the following: (1) at least one of A, (2) at least one of B, and (3) at least one of A and at least one of B. Likewise, the scope of the expression or phrase “at least one of A, B, or C” is intended to include all of the following: (1) at least one of A, (2) at least one of B, (3) at least one of C, (4) at least one of A and at least one of B, (5) at least one of A and at least one of C, (6) at least one of B and at least one of C, and (7) at least one of A, at least one of B, and at least one of C.

While the disclosure has been described with respect to various example embodiments, each example is provided by way of explanation, not limitation of the disclosure. Those skilled in the art, upon attaining an understanding of the foregoing, can readily produce alterations to, variations of, and equivalents to such embodiments. Accordingly, the disclosure does not preclude inclusion of such modifications, variations and/or additions to the disclosed subject matter as would be readily apparent to one of ordinary skill in the art. For example, features illustrated or described as part of one embodiment can be used with another embodiment to yield a still further embodiment. Thus, it is intended that the disclosure covers such alterations, variations, and equivalents.

What is claimed is:

1. A computer-implemented method, comprising:
providing, by a computing system, a virtual three-dimensional (3D) environment in which a first user and a second user simultaneously view the virtual 3D environment;
receiving, by the computing system, a first input associated with the first user, to cause a generative machine-learned model to generate a first virtual object within the virtual 3D environment, the first virtual object being embedded with a first unique digital signature associated with the first user;
receiving, by the computing system, a second input associated with the second user, to cause the generative machine-learned model to generate a second virtual object within the virtual 3D environment, the second virtual object being generated based on the second input and contextual information associated with the second user and the second virtual object being embedded with a second unique digital signature associated with the second user; and
causing, by the computing system, a third unique digital signature to be associated with the virtual 3D environment including the first virtual object and the second virtual object, the third unique digital signature being associated with the first user and the second user.

2. The computer-implemented method of claim 1, wherein one or more of the first unique digital signature, the second unique digital signature, and the third unique digital signature, comprises a non-fungible token.

3. The computer-implemented method of claim 1, further comprising:
in response to generating the second virtual object, providing the second user access to another virtual 3D environment using the second unique digital signature or using a separate property embedded with the second virtual object.

4. The computer-implemented method of claim 3, further comprising:
identifying, by the computing system, the another virtual 3D environment as a virtual 3D environment to provide access to the second user to, based on at least one of the second input associated with the second user or the contextual information associated with the second user.

5. The computer-implemented method of claim 4, wherein the separate property includes a digital utility token.

6. The computer-implemented method of claim 1, further comprising:
in response to the generation of the second virtual object, providing the second user access to a real-world experience using the second unique digital signature or using a separate property embedded with the second virtual object.

7. The computer-implemented method of claim 6, further comprising:
identifying, by the computing system, the real-world experience as a real-world experience to provide access to the second user to, based on at least one of the second input associated with the second user or the contextual information associated with the second user.

8. The computer-implemented method of claim 7, wherein the separate property includes a digital utility token.

9. The computer-implemented method of claim 1, further comprising:
receiving, by the computing system, a third input associated with the first user, to cause the generative machine-learned model to modify the second virtual object to generate a modified second virtual object within the virtual 3D environment, the modified second virtual object being generated based on the third input and contextual information associated with the first user and the modified second virtual object being embedded with a fourth unique digital signature associated with the first user.

10. The computer-implemented method of claim 9, further comprising:
obtaining, by the computing system, the contextual information associated with the first user based on at least one of a user profile associated with the first user, preferences associated with the first user, or information about the first user obtained from an external source.

11. The computer-implemented method of claim 1, further comprising:
receiving, by the computing system, a third input associated with an entity not simultaneously viewing the virtual 3D environment with the first user and the second user, to cause the generative machine-learned model to modify the second virtual object to generate a modified second virtual object within the virtual 3D environment, the modified second virtual object being generated based on the third input and contextual information associated with the entity and the modified second virtual object being embedded with a fourth unique digital signature associated with the entity.

12. The computer-implemented method of claim 11, further comprising:
obtaining, by the computing system, the contextual information associated with the entity based on information about the entity obtained from an external source.

13. The computer-implemented method of claim 1, wherein the virtual 3D environment includes a virtual reality environment or an augmented reality environment.

14. The computer-implemented method of claim 1, further comprising:
receiving, by the computing system, a third input associated with the first user, to cause the generative machine-learned model to modify the virtual 3D environment by changing an environmental condition of the virtual 3D environment to generate a modified virtual 3D environment, the modified virtual 3D environment being embedded with a fourth unique digital signature associated with the first user.

15. The computer-implemented method of claim 14, wherein the environmental condition includes one more of a lighting condition of the virtual 3D environment, a weather condition of the virtual 3D environment, a noise condition of the virtual 3D environment, a time of day in the virtual 3D environment, or a geographic location of the virtual 3D environment.

16. A computing system, comprising:
one or more processors; and
one or more non-transitory computer-readable media that store instructions that, when executed by the one or more processors, cause the computing system to perform operations, the operations comprising:
providing a virtual three-dimensional (3D) environment in which a first user and a second user simultaneously view the virtual 3D environment;
receiving a first input associated with the first user, to cause a generative machine-learned model to generate a first virtual object within the virtual 3D environment, the first virtual object being embedded with a first unique digital signature associated with the first user;
receiving a second input associated with the second user, to cause the generative machine-learned model to generate a second virtual object within the virtual 3D environment, the second virtual object being generated based on the second input and contextual information associated with the second user and the second virtual object being embedded with a second unique digital signature associated with the second user; and
causing a third unique digital signature to be associated with the virtual 3D environment including the first virtual object and the second virtual object, the third unique digital signature being associated with the first user and the second user.

17. The computing system of claim 16, wherein one or more of the first unique digital signature, the second unique digital signature, and the third unique digital signature, comprises a non-fungible token.

18. The computing system of claim 16, wherein the operations further comprise:
receiving a third input associated with the first user, to cause the generative machine-learned model to modify the second virtual object to generate a modified second virtual object within the virtual 3D environment, the modified second virtual object being generated based on the third input and contextual information associated with the first user and the modified second virtual object being embedded with a fourth unique digital signature associated with the first user.

19. The computing system of claim 16, wherein the operations further comprise:
receiving a third input associated with an entity not simultaneously viewing the virtual 3D environment with the first user and the second user, to cause the generative machine-learned model to modify the second virtual object to generate a modified second virtual object within the virtual 3D environment, the modified second virtual object being generated based on the third input and contextual information associated with the entity and the modified second virtual object being embedded with a fourth unique digital signature associated with the entity.

20. A computer-implemented method, comprising:
providing, by a computing system, a virtual three-dimensional (3D) environment in which a first user and a second user simultaneously view the virtual 3D environment;
receiving, by the computing system, a first input associated with the first user, to cause a generative machine-learned model to generate a first virtual object within the virtual 3D environment and change an environmental condition of the virtual 3D environment to generate a modified virtual 3D environment, the first virtual object being embedded with a first unique digital signature associated with the first user and the modified virtual 3D environment being embedded with a second unique digital signature associated with the first user;
receiving, by the computing system, a second input associated with the second user, to cause the generative machine-learned model to modify the first virtual object to generate a modified first virtual object within the virtual 3D environment, the modified first virtual object being generated based on the second input and contextual information associated with the second user and the modified first virtual object being embedded with a third unique digital signature associated with the second user;
causing, by the computing system, a fourth unique digital signature to be associated with the modified virtual 3D environment including the modified first virtual object, the fourth unique digital signature being associated with the first user and the second user; and
in response to the generation of the first virtual object or the modified virtual 3D environment, providing access to one or more of a real-world experience or another virtual environment experience to the first user, using the first unique digital signature or the second unique digital signature.
